(19) United States
(12) Patent Application Publication
(10) Pub. No.: US 2017/0122472 A1
(43) Pub. Date: May 4, 2017

(54) ADAPTER COUPLING

(71) Applicant: Parker-Hannifin Corporation, Cleveland, OH (US)

(72) Inventors: Ricardo Meza, Katy, TX (US); Harsh Rajnikant Parekh, Houston, TX (US)

(21) Appl. No.: 15/258,538

(22) Filed: Sep. 7, 2016

Related U.S. Application Data
(60) Provisional application No. 62/248,395, filed on Oct. 30, 2015.

(51) Int. Cl. F16L 37/138; F16L 37/252; F16L 21/08

(52) U.S. Cl. CPC F16L 37/138; F16L 21/08; F16L 37/252

(57) ABSTRACT

A coupling adapter for locking engagement of a hose adapter to a tank adapter includes a locking slide for engaging the hose adapter and a coupling sleeve for attaching the locking slide to the tank adapter while allowing axially shifting movement of the locking slide along a central longitudinal axis of the coupling adapter between a retracted release position allowing release of the hose adapter from the locking slide and an extended locking position preventing release of the hose adapter from the locking slide, and a resilient member for resiliently biasing the locking slide towards its extended locking position. The locking slide and the coupling sleeve have cooperating elements that rotationally interfere with one another when the locking slide is in the extended locking position to restrict rotation of the locking slide relative to the coupling sleeve in at least one direction.

### FIELD OF INVENTION

The present invention relates generally to a locking mechanism, and more particularly to a locking mechanism for preventing decoupling of corresponding fluid transfer lines from one another.

### BACKGROUND

Anhydrous ammonia may be applied to soil by farmers as a fertilizer. Farmers often use a nurse tank containing pressurized liquid anhydrous ammonia as a source. The nurse tank may be stationary and used to fill an intermediary tank, or the nurse tank may be provided on a cart that is transported by an agricultural vehicle across a field while the anhydrous ammonia is distributed to the soil via a tool bar connected to the nurse tank. The tool bar may include knives or other implements for directing the anhydrous ammonia into the ground.

To draw anhydrous ammonia from the nurse tank, a delivery hose is connected to the nurse tank, such as to a withdrawal adapter attached to an internal withdrawal valve of the nurse tank. The withdrawal adapter often includes external or internal threading, such as acme threading, for coupling to corresponding internal or external threading of a hose adapter attached to the delivery hose. During pulling of the cart and tool bar, such as over a field, the adapters coupling together the tool bar and the nurse tank may loosen or come apart all together due to vibration. Such an occurrence is undesirable.

### SUMMARY OF INVENTION

There is a coupling adapter for locking engagement of a hose adapter to a tank adapter that includes (a) a locking slide for engaging the hose adapter and (b) a coupling sleeve for attaching the locking slide to the second adapter. The locking slide is allowed to axially shift between a retracted release position allowing release of the hose adapter from the locking slide and an extended locking position preventing release of the hose adapter from the locking slide. A resilient member resiliently biases the locking slide towards its extended locking position. The locking slide and the coupling sleeve have cooperating elements that rotationally interfere with one another when the locking slide is in the extended locking position to restrict rotation of the locking slide and the hose adapter engaged therewith relative to the coupling sleeve in at least one rotational direction.

According to one aspect there is a coupling adapter for locking engagement of corresponding first and second adapters of a fluid transfer system. The coupling adapter includes a locking slide for engaging the first adapter, a coupling sleeve for attaching the locking slide to the second adapter while allowing axially shifting movement of the locking slide along a central longitudinal axis of the coupling adapter between a retracted release position allowing release of the first adapter from the locking slide and an extended locking position preventing release of the first adapter from the locking slide, and a resilient member for resiliently biasing the locking slide towards its extended locking position. The locking slide and the coupling sleeve have cooperating elements that rotationally interfere with one another when the locking slide is in the extended locking position to restrict rotation of the locking slide relative to the coupling sleeve in at least one direction.

The locking slide may be configured to couple with the first adapter for joint rotational movement of the locking slide and the first adapter when the locking slide is in the extended locking position.

The cooperating elements may rotationally interfere with one another when the locking slide is in the extended locking position to restrict joint rotation of the locking slide and the first adapter relative to the coupling sleeve in at least one direction.

The locking slide may have at an end for receiving the first adapter a non-circular engaging surface for restricting rotation of the first adapter relative to the locking slide.

The cooperating elements may be configured to rotationally interfere with one another when the locking slide is in the extended locking position to prevent rotational separation of the first and second adapters from a threadedly engaged orientation.

The cooperating elements may be configured to allow rotational connection of the first and second adapters from a separated orientation to a threadedly engaged orientation when the locking slide is in the extended locking position.

The cooperating elements may include interengaging projections at each of the locking slide and the coupling sleeve that are shaped to pass one another in a first rotational direction of the locking slide but to impede rotational movement past one another in a second and opposite rotational direction of the locking slide.

The cooperating elements of the locking slide may be disposed on a radially outward surface and the cooperating elements of the coupling sleeve are disposed on a radially inward surface.

The cooperating elements of the locking slide and the coupling sleeve may be disposed on corresponding axial end surfaces of the locking slide and the coupling sleeve.

The coupling adapter may include a union mount for fixedly attaching to the second adapter and for attaching the coupling sleeve to the second adapter, wherein the coupling sleeve may be rotationally fixed relative to the union mount while allowing joint axially shifting movement of the coupling sleeve and the locking slide along the central longitudinal axis of the coupling adapter.

The coupling sleeve may be configured for rotational fixation relative to the second adapter while allowing joint axially shifting movement of the coupling sleeve and the locking slide along the central longitudinal axis of the coupling adapter.

The coupling adapter may be in combination with the first and second adapters, wherein the first and second adapters each include cooperating Acme threads.

There may be a method of providing locking engagement of the first and second adapters using the coupling adapter, the method including the steps of: (a) rotationally fixedly attaching the coupling sleeve to the second adapter, and (b) threading together the first and second adapters while the locking slide is in the extended locking position.

The method may further including the step of engaging the locking slide with the first adapter for joint rotational movement of the locking slide with the first adapter in a first rotational direction allowing threading engagement of the first and second adapters.

According to another aspect, there is coupling adapter for locking in threaded engagement a tank adapter and a hose adapter. The coupling adapter includes a locking slide for engaging the hose adapter and a coupling sleeve for attaching the locking slide and the tank adapter, where the coupling sleeve is rotationally fixed relative to the tank adapter. The locking slide is axially shiftable between a retracted release position allowing release of the hose adapter from the locking slide and an extended locking position preventing release of the hose adapter from the locking slide. The locking slide and the coupling sleeve are jointly configured to allow rotational engagement of the hose adapter with the tank adapter via rotation of the tank adapter or the hose adapter in a threading rotational direction. The locking slide and the coupling sleeve are jointly configured to prevent rotational disengagement of the hose adapter relative to the tank adapter via rotation of the tank adapter or the hose adapter in an opposite unthreading rotational direction when the locking slide is in the extended locking position.

The locking slide and the coupling sleeve may be jointly configured to allow rotational engagement of the hose adapter with the tank adapter while the locking slide is in either of the extended locking position or the retracted release position.

Each of the locking slide and the coupling sleeve may have cooperating elements that rotationally interfere with one another when the locking slide is in the extended locking position to restrict rotation of the locking slide relative to the coupling sleeve in at least one direction.

The coupling adapter may further include a resilient biasing member for biasing the locking slide to the extended locking position.

The locking slide may have at an end for receiving the hose adapter a non-circular engaging surface for engaging a corresponding surface of the hose adapter for joint rotational movement therewith and for restricting rotation of the hose adapter relative to the locking slide.

According to yet another aspect, there is a coupling assembly including a tank adapter for attachment to a tank, a hose adapter for threaded attachment to the tank adapter and for attachment to a hose, and a coupling adapter coupled to the tank adapter for locking together the tank adapter and the hose adapter in threaded engagement. The coupling adapter includes a locking slide axially shiftable along the tank adapter, the locking slide engageable with the hose adapter when axially biased in an extended locking position such that the locking is rotatable with the hose adapter upon threaded engagement of the hose adapter and the tank adapter. The coupling adapter also includes a resilient biasing member biasing the locking slide in the extended locking position, and a coupling sleeve attaching the locking slide to the tank adapter. Each of the locking slide and the coupling sleeve have cooperating elements that rotationally interfere with one another when the locking slide is in the extended locking position to restrict rotation of the locking slide relative to the coupling sleeve in at least one direction. The cooperating elements allow threaded attachment of the hose adapter with the tank adapter regardless of the axial position of the locking slide along the tank adapter.

The foregoing and other features of the invention are hereinafter described in greater detail with reference to the accompanying drawings.

### BRIEF DESCRIPTION OF THE DRAWINGS

The annexed drawings, which are not necessarily to scale, show various aspects of the disclosure.

FIG. 1 is a partial schematic perspective view of a cart having tanks with adapter couplings according to the invention for lockingly coupling fluid lines to the tanks.

FIG. 2 is an exploded side view of an exemplary coupling assembly including an exemplary adapter coupling according to the invention.

FIG. 3 is a side view of the exemplary coupling assembly of FIG. 2.

FIG. 4 is a perspective view of the exemplary coupling assembly of FIG. 2.

FIG. 5 is another perspective view of the exemplary coupling assembly of FIG. 2.

FIG. 6 is an end view of the exemplary coupling assembly of FIG. 2.

FIG. 7 is another end view of the exemplary coupling assembly of FIG. 2.

FIG. 8 is an exploded view of the end view of FIG. 7.

FIG. 9 is a partial cross-sectional view of the exemplary coupling assembly of FIG. 2 showing the exemplary coupling adapter in a locked engagement.

FIG. 10 is a partial cross-sectional view of the exemplary coupling assembly of FIG. 2, showing the exemplary coupling adapter in an unlocked engagement.

FIG. 11 is a partial cross-sectional view of the exemplary coupling assembly of FIG. 2 showing male and female adapters of the coupling assembly separated from one another.

FIG. 12 is an exploded side view of another exemplary coupling assembly including another exemplary adapter coupling according to the invention.

FIG. 13 is a side view of the exemplary coupling assembly of FIG. 12.

FIG. 14 is a perspective view of the exemplary coupling assembly of FIG. 12.

FIG. 15 is another perspective view of the exemplary coupling assembly of FIG. 12.

FIG. 16 is an end view of the exemplary coupling assembly of FIG. 12.

FIG. 17 is another end view of the exemplary coupling assembly of FIG. 12.

FIG. 18 is an exploded view of the end view of FIG. 17.

FIG. 19 is a partial cross-sectional view of the exemplary coupling assembly of FIG. 12 showing the exemplary coupling adapter in a locked engagement.

FIG. 20 is a partial cross-sectional view of the exemplary coupling assembly of FIG. 12, showing the exemplary coupling adapter in an unlocked engagement.

FIG. 21 is a partial cross-sectional view of the exemplary coupling assembly of FIG. 12 showing male and female adapters of the coupling assembly separated from one another.

### DETAILED DESCRIPTION

The principles of the present disclosure have general application to couplings or adapters for connecting a source of fluid to a fluid delivery element, and more particular application to adapters, such as Acme adapters, for connecting a source of anhydrous ammonia to a tool bar for distributing the anhydrous ammonia to soil, and thus will be described below chiefly in this context. It will of course be appreciated, and also understood, that the principles of the invention may be useful in other fluid coupling applications where it is desirable to lockingly engage together adapters in the fluid line between a source of fluid, such as a nurse tank, and the fluid distributor, such as a tool bar, to prevent the adapters from coming loose from one another due to vibration or other forces.

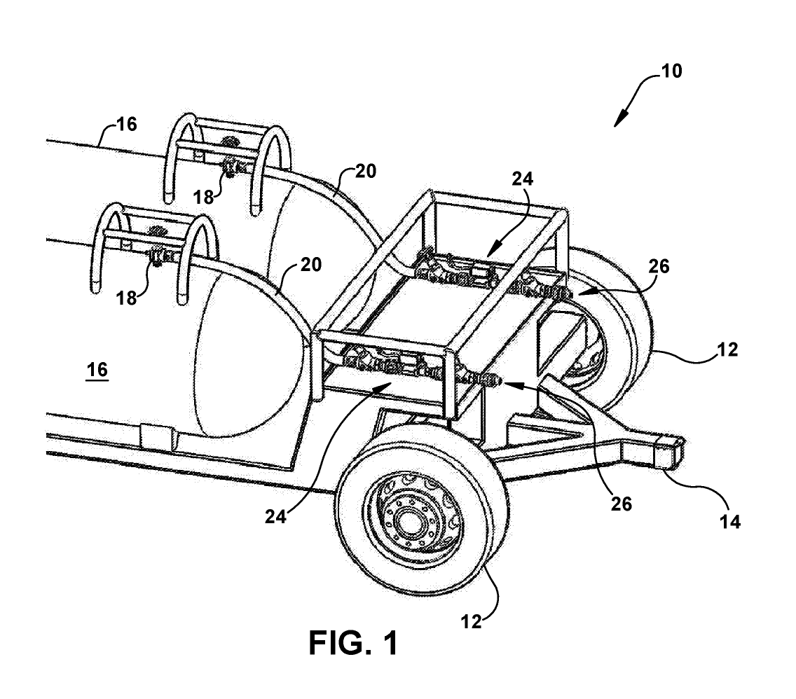

Turning now to FIG. 1, an exemplary anhydrous ammonia cart, such as a nurse tank cart, is illustrated generally at reference numeral 10. The cart 10 may include a plurality of wheels 12, a hitch 14 configured to couple to a tool bar that couples to a farm vehicle, and a plurality of nurse tanks 16 containing pressurized liquid anhydrous ammonia. As used herein, coupling may include direct or indirect coupling.

Each tank 16 includes a withdrawal valve 18 through which the liquid exits the tank 16. The withdrawal valves 18 are coupled to respective hoses 20 using adapters, such as male and female adapters, threadedly engaged to one another. The flexible hoses 20 may be coupled to any number of suitable valves 24, such as flow meter valves, shut off valves, etc. A distal end 26 of the valve chain may be connected to a tool bar, for example, having knives for directing the liquid into the soil of a field.

It is often the case that during movement of a cart over a field, such as the exemplary cart 10, at least one adapter of a pair of threadedly engaged adapters can loosen from the other adapter of the pair of threadedly engaged adapters. The unthreading loosening can be caused by vibration, improper tightening, a combination thereof, or any other force suitable for loosening threaded adapters, causing fluid leakage, loss of pressure in the line, or a loss of fluid connection altogether.

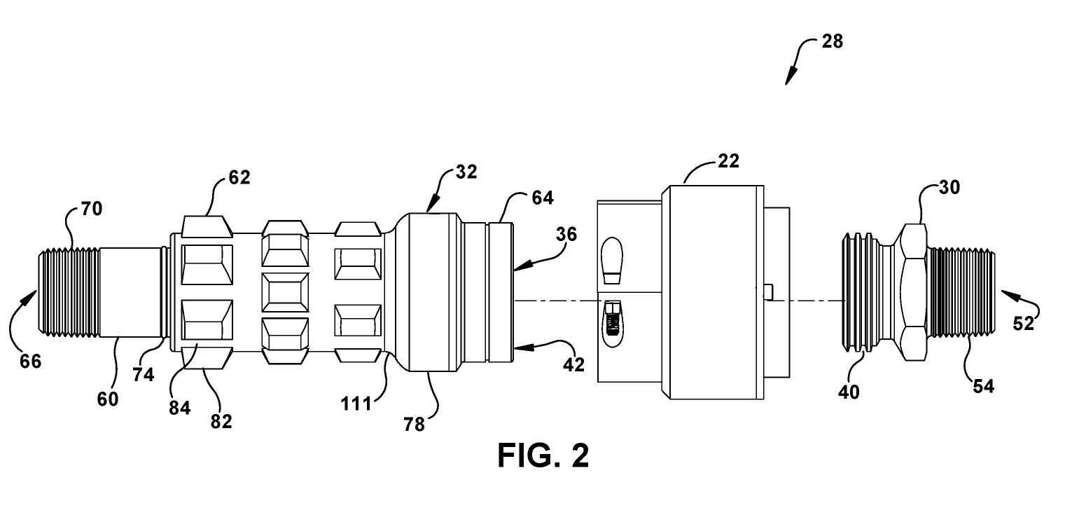

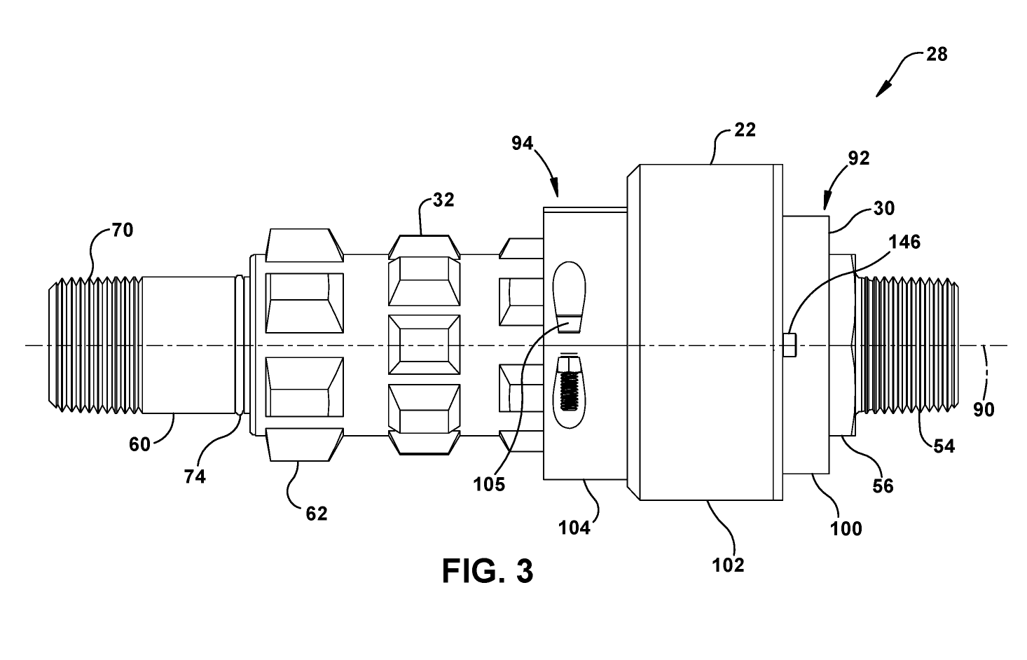

Turning now to FIGS. 2 and 3, a coupling adapter 22 is illustrated that may overcome these disadvantages by lockingly engaging together adapters of a fluid transfer system. With respect to the cart 10, any number of exemplary coupling adapters 22 may be used where suitable to lockingly engage adapters to one another. For example, an exemplary coupling adapter 22 may be used to lockingly engage together a corresponding male adapter and female adapter, such as a male hose adapter and a female tank adapter.

In the depicted embodiment of FIGS. 2 and 3, a coupling assembly 28 is shown having an exemplary coupling adapter 22 for lockingly engaging a first adapter 30 and a second adapter 32. In the depicted embodiment, the first adapter is a male hose adapter 30, for example of a hose for drawing fluid from a supply tank, and the second adapter is a female tank adapter 32, for example of a withdrawal valve of a supply tank or for attaching to a withdrawal valve of a supply tank.

The exemplary coupling adapter 22 can be used to restrict or all together prevent relative loosening of the hose adapter 30 and the tank adapter 32. The exemplary coupling adapter 22 can provide additional advantages such as automatic locking engagement and positive disengagement of the adapter 22 with one or more of the hose adapter 30 or the tank adapter 32, to be further described.

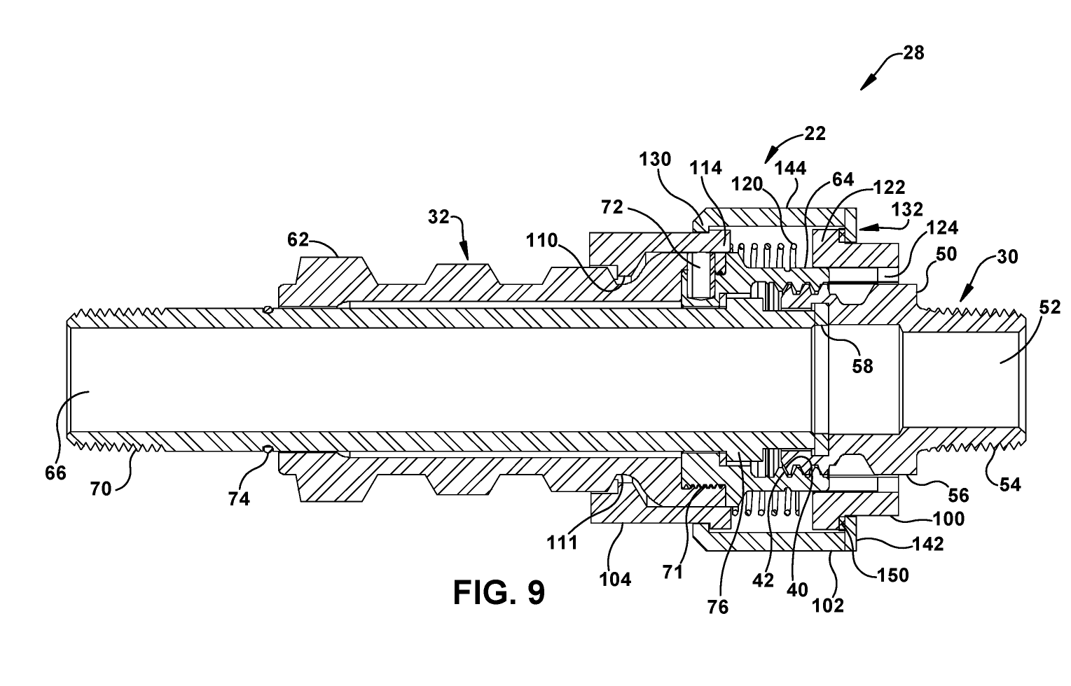

Referring in detail to the hose adapter 30 and the tank adapter 32, the adapters are typically threaded together, and often each have complimentary threads, such as Acme threads. The hose adapter 30 is typically a male adapter that is received in a suitable cavity 36 of a female tank adapter 32, where the male hose adapter 30 has threads 40 (FIG. 9) on an outer radial surface and the female tank adapter 32 has threads 42 (FIG. 9) an inner radial surface. One of ordinary skill in the art will of course appreciate that the exemplary coupling adapter 22 may be adapted in an opposite scenario, such as with a female hose adapter and a male tank adapter.

The illustrated male hose adapter 30 has a body 50 that defines a fluid passage 52 extending therethrough for directing fluid from the tank adapter 32. A first end of the hose adapter 30 includes the threads 40 (FIG. 9) for engaging the tank adapter 32. A second end of the hose adapter 30 opposite the first end includes additional engagement elements 54, such as threads or ribs, for engaging a respective element, such as a hose of a cart. It will be appreciated that engagement elements 54 may be any suitable elements for either permanently or removably attaching to the respective element.

Disposed between the threads 40 and engagement elements 54, the body 50 defines a non-circular outer surface 56 for engagement with an exemplary coupling adapter 22. For example, the non-circular outer surface 56 may have any suitable number of flats, such as being hexagon-shaped. The hose adapter 30 may also include a seal 58 (FIG. 9), such as an o-ring, retained in the fluid passage 52 for allowing sealing between the hose adapter 30 and a portion of the tank adapter 32.

The illustrated female tank adapter 32, to which the hose adapter 30 may be threaded, includes a tank sleeve 62 and a threaded sleeve 64, while a tank nozzle 60 is received by the tank adapter 32 and captivated between the tank adapter 32 and the hose adapter 30 once relatively coupled. The tank adapter 32 is attached to the supply via the tank nozzle 60.

The tank nozzle 60 defines a fluid passage 66 extending therethrough for directing fluid from a supply source, such as a tank, towards the hose adapter 30. The tank nozzle 60 includes at one end engagement elements 70, such as threads or ribs, for allowing attachment to a respective element, such as a supply source. It will be appreciated that engagement elements 70 may be any suitable elements for either permanently or removably attaching to the respective element. An opposite end of the tank nozzle 60 is shaped to be received into the fluid passage 52 of the hose adapter 30 into engagement with the seal 58.

The tank sleeve 62 and threaded sleeve 64 are disposed about the tank nozzle 60. The tank sleeve 62 is coupled to the threaded sleeve 64, such as by corresponding threads 71 (FIG. 9) of each of the sleeves 62 and 64 and by a locking pin 72 (FIG. 9). In other embodiments, the tank sleeve 62 and threaded sleeve 64 may be coupled via other projections, welding, etc., or may be integral with one another. The coupling together of the tank sleeve 62 and the threaded sleeve 64 allows the sleeves to jointly rotate with one another about the tank nozzle 60 for allowing engagement of the threads 40 (FIG. 9) of the hose adapter 30 with the threads 42 (FIG. 9) of the threaded sleeve 64. The tank sleeve 62 and threaded sleeve 64 are translationally limited along the tank nozzle 60, such as via a locking ring 74 at one axial end and a projection 76 (FIG. 9) of the tank nozzle 60 at an opposite axial end. As shown, the projection 76 is a radially outwardly extending projection.

The tank sleeve 62 also includes a collar 78 at one end for receiving the threaded sleeve 64 and a plurality of non-circular engagement lugs 82 disposed about the tank sleeve 62 and axially spaced from the collar 78. The lugs 82 may include flats defining shapes for engagement with one or more tools. The lugs 82 are circumferentially separated about a central longitudinal axis 90 (FIG. 3) by indents 84 therebetween. Groups of lugs 82 extending circumferentially about the tank sleeve 62 are also axially spaced from one another along the central longitudinal axis 90.

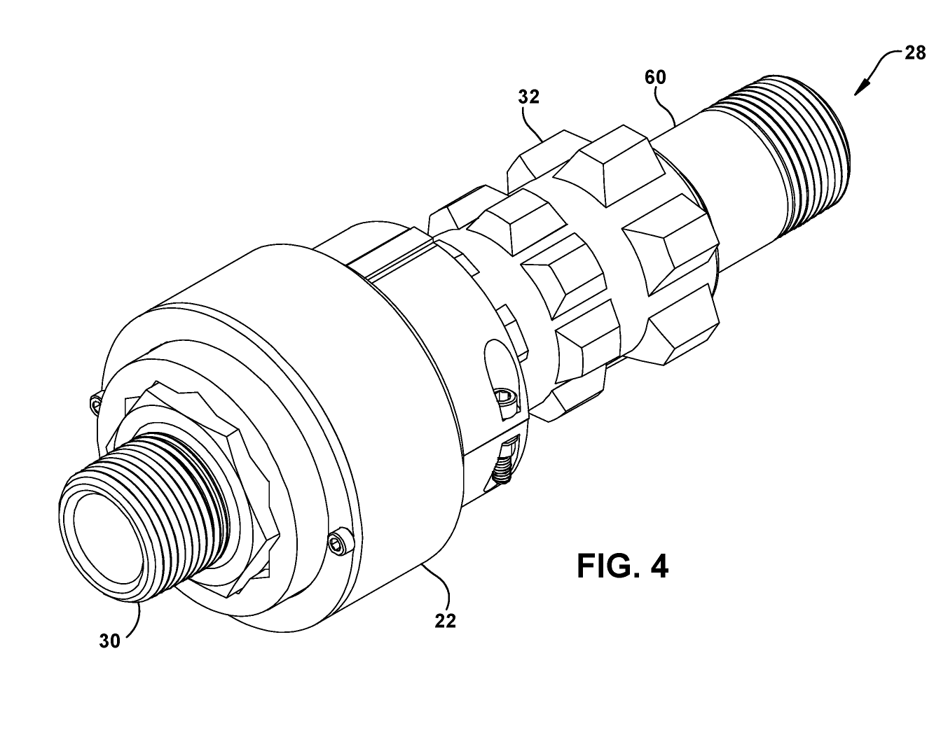

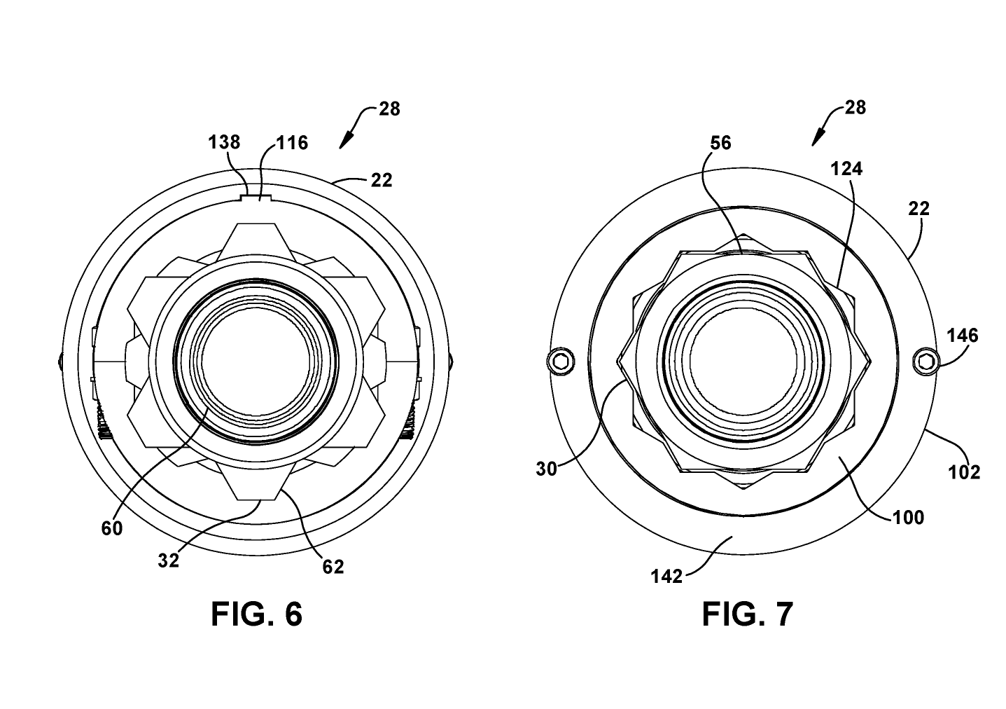

Referring now to FIGS. 3-9, the exemplary coupling adapter 22 is configured for engagement with each of the tank adapter 32 and the hose adapter 30 to prevent relative separation, such as axial separation, of the tank adapter 32 and the hose adapter 30. The coupling adapter 22 extends along the central longitudinal axis 90 (FIG. 3) between a first end 92 for coupling to the tank adapter 32 and a second end 94 for coupling to the hose adapter 30. The coupling adapter 22 includes a locking slide 100 for engaging the hose adapter 30, and a coupling sleeve 102 for attaching the locking slide 100 to the tank adapter 32, such as via a union mount 104 of the coupling adapter 22. The coupling adapter 22 may be made of any suitable materials, such as metals that are compatible with anhydrous ammonia.

Referring to the union mount 104 in detail, the union mount 104 surrounds the tank adapter 32 and is fixedly coupled to the tank sleeve 62. The union mount 104 includes two portions, such as halves, that are separable, such as to allow the union mount 104 to be fixed to the tank adapter 32. The halves are coupled together, such as via threaded members 105 (FIG. 3), although other suitable coupling methods may be used, such as snap fits, welding, etc. A nut may be used in the case of a threaded member, as depicted, or one or more of the union mount halves may be correspondingly threaded. In some embodiments, the union mount 104 may include more than two portions.

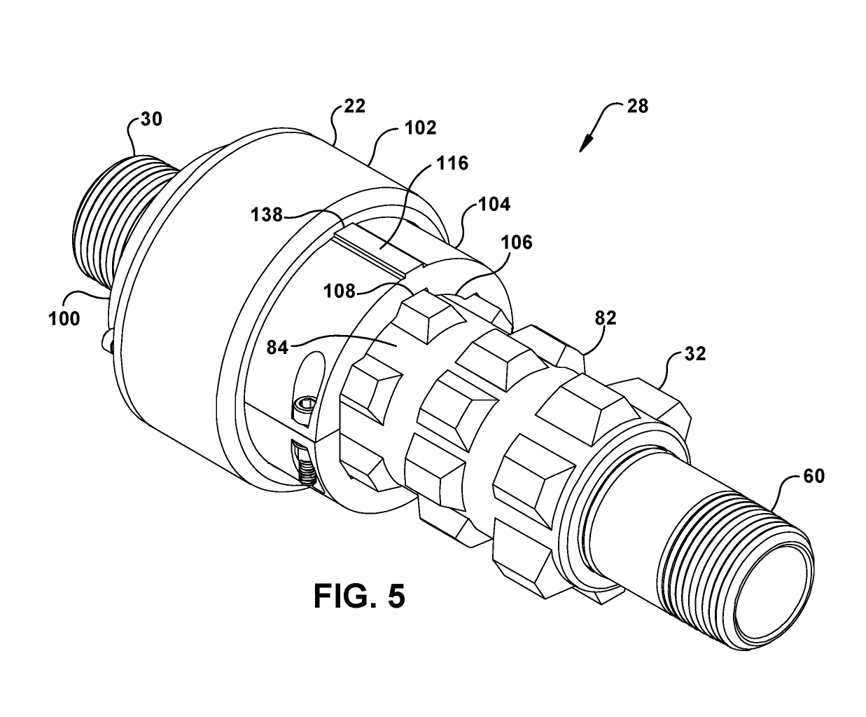

As shown best in FIG. 5, the union mount 104 includes locking projections 106 at a rear end. The locking projections 106 extend radially inward towards the central longitudinal axis 90 and are separated circumferentially about the central longitudinal axis 90 via locking indents 108. The locking projections 106 are received in the indents 84 of the tank sleeve 62, while the lugs 82 of the tank sleeve 62 are likewise received in the locking indents 108 of the union mount 104.

As shown best in FIG. 9, the union mount 104 also includes an inner locking element 110 extending radially inwardly for being received into a locking space 111 defined between the collar 78 and a first grouping of lugs 82 of the tank sleeve 62. In this way, the union mount 104 is both rotationally fixed and translationally fixed relative to the tank sleeve 62 and thus relative to the tank adapter 32. It will be appreciated that the inner locking element 110 may have any suitable shape for preventing translation of the union mount 104 relative to the tank adapter 32.

At a forward end of the union mount 104, opposite the rear end, a mount lip 114 extends radially outwardly for engaging a corresponding lip of the coupling sleeve 102, thereby limiting axial shifting of the coupling sleeve 102 relative to the union mount 104. An anti-rotation key 116 (FIG. 5) extends along an outer surface of the union mount 104 parallel to the central longitudinal axis 90 for engaging a corresponding groove of the coupling sleeve 102 to prevent rotation of the coupling sleeve 102 relative to the union mount 104, and therefore relative to the tank adapter 32. It will be appreciated that in other embodiments, the coupling sleeve 102 may include a key while the union mount 104 includes a corresponding groove.

Referring to the locking slide 100 in detail, the locking slide 100 is coupled to the union mount 104, and thus to the tank adapter 32, via the coupling sleeve 102, to be further explained. The coupling together allows axially shifting movement of the locking slide 100 along the central longitudinal axis 90 of the coupling adapter 22. The locking slide 100 is axially shiftable relative to each of the coupling sleeve 102, the union mount 104, and the tank adapter 32 between a retracted release position and an extended locking position. In the retracted position, the locking sleeve 100 is at a position closest to the union mount 104. In the extended locking position, the locking sleeve 100 is at a position spaced farthest from the union mount 104.

A resilient member 120 (FIG. 9) is disposed between the union mount 104 and the locking slide 100 to bias the locking slide 100 toward its extended locking position. The resilient member 120 may be any suitable biasing member, such as a spring as illustrated.

The locking slide 100 has at a rear end a boss 122 extending radially outwardly for engaging the coupling sleeve 102 and for preventing axial separation of the locking slide 100 from the coupling sleeve 102 and union mount 104 when the coupling adapter 22 is attached to the tank adapter 32.

At a forward end opposite the rear end, the locking slide 100 is configured to couple with the hose adapter 30 for joint rotational movement therewith when the locking slide 100 is in the extended locking position. As illustrated, the locking slide 100 has at the forward end for receiving the hose adapter 30 a non-circular engaging surface 124 for engaging the corresponding non-circular outer surface 56 of the hose adapter 30.

When the locking slide 100 is biased forward in the extended locking position, the locking slide 100 is positioned to engage the hose adapter 30 once the hose adapter 30 is threaded to the tank adapter 32. As shown particularly in FIG. 9, the locking slide 100 and the hose adapter 30 are engaged for joint rotational movement. Thus rotational movement of the hose adapter 30 relative to the locking slide 100 is restricted or all together prevented with the locking slide 100 in the extended locking position.

Referring to the coupling sleeve 102 in detail, the coupling sleeve 102 is translationally captivated between the locking slide 100 and the union mount 104. A rear radially inward projection 130 is shaped to engage the mount lip 114 of the union mount 104 to prevent axial separation of the coupling sleeve 102 from the union mount 104. Additionally, a forward radially inward projection 132 is shaped to engage the boss 122 of the locking slide 100 to prevent axial separation of the locking slide 100 from the coupling sleeve 102. The coupling sleeve 102 also has groove 138 for receiving the anti-rotation key 116 of the union mount 104. In this way, the coupling sleeve 102 is configured for rotational fixation relative to the union mount 104 and relative to the tank adapter 32 while allowing joint axially shifting movement of the coupling sleeve 102 and the locking slide 100 along the central longitudinal axis 90 of the coupling adapter 22.

The coupling sleeve 102 further has a retainer member 142 at a forward end of the coupling sleeve 102 that may be separated from a remaining body 144 of the coupling sleeve 102. The retainer member 142 at least partially defines the forward radially inward projection 132 of the coupling sleeve 102. The body 144 and retainer member 142 are coupled together, such as via threaded members 146. In the illustrated embodiment, the body 144 and the retainer member 142 are separable to allow for assembly of the coupling adapter 22, such as for insertion of the resilient member 120 and/or the locking slide 100 into a cavity defined between the coupling sleeve 102 and the tank adapter 32. As will be appreciated, any suitable number of threaded members 146 may be used.

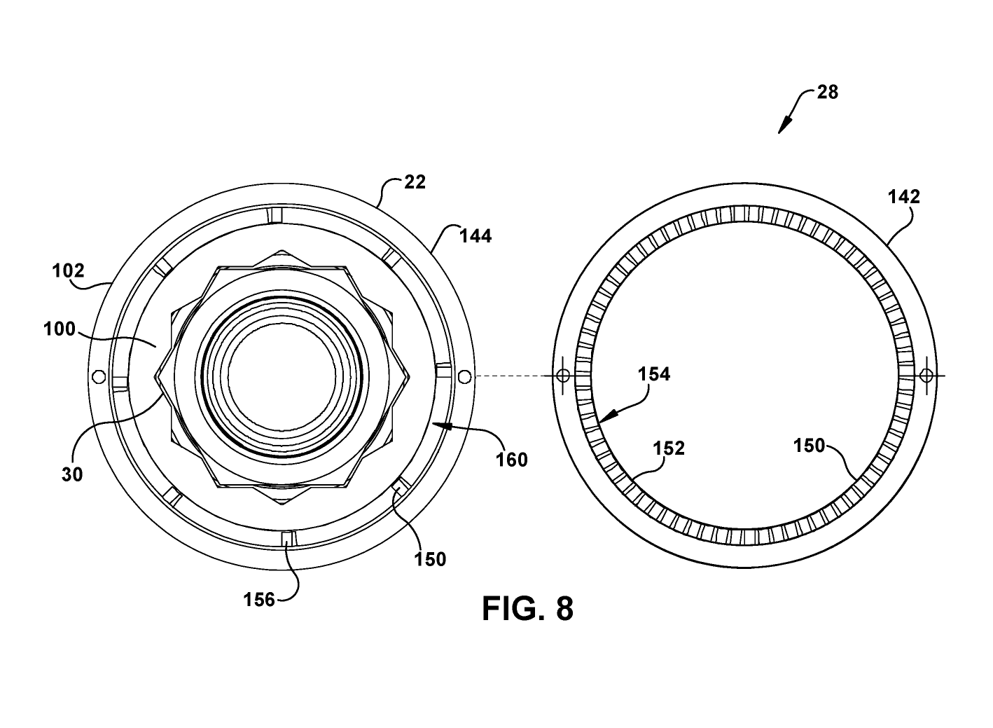

Referring now in particular to FIGS. 8 and 9, each of the coupling sleeve 102 and the locking slide 100 have cooperating elements 150. The cooperating elements 150 rotationally interfere with one another when the locking slide 100 is in the extended locking position to restrict rotation of the locking slide 100 relative to the coupling sleeve 102, and relative to the union mount 104, in at least one direction. In the illustrated embodiment, the retainer member 142 has sleeve interference projections 152 at a rear axial end surface 154. The locking slide 100 also has slide interference projections 156 at a forward axial end surface 160 of the boss 122. The corresponding axial end surfaces 154 and 160 are disposed adjacent one another when the locking slide 100 is in the extended locking position, causing the interference projections 152 and 156, referred to jointly as the cooperating elements 150, to be interengaged. In this way, joint rotation of the locking slide 100 and the hose adapter 132 relative to the coupling sleeve 102 is restricted in at least one direction.

For example, the interengaging interference projections 152 and 156 are shaped, such as having cam surfaces, to pass one another in a first rotational direction of the locking slide 100 but are also shaped, such as via opposite non-cam surfaces to impede rotational movement past one another in a second and opposite rotational direction of the locking slide 100. As shown, the cooperating elements 150 are configured to rotationally interfere with one another when the locking slide 100 is in the extended locking position to prevent rotational separation of the hose adapter 30 and the tank adapter 32 from a threadedly engaged orientation. Likewise, the cooperating elements 150 are configured to allow rotational connection of the hose adapter 30 and the tank adapter 32 from a separated orientation to the threadedly engaged orientation when the locking slide 100 is in the extended locking position.

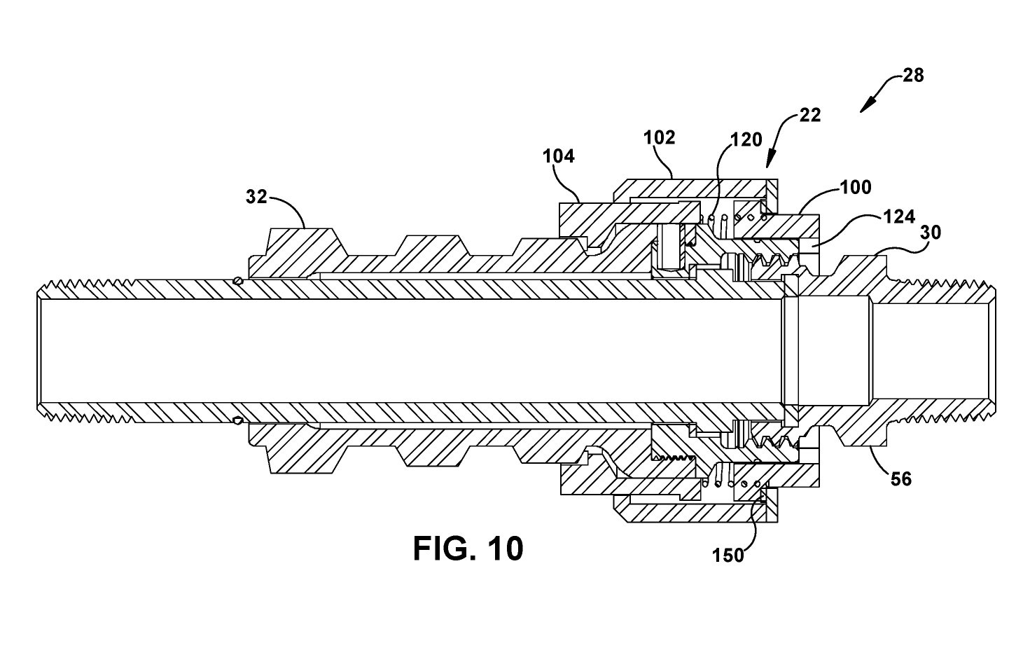

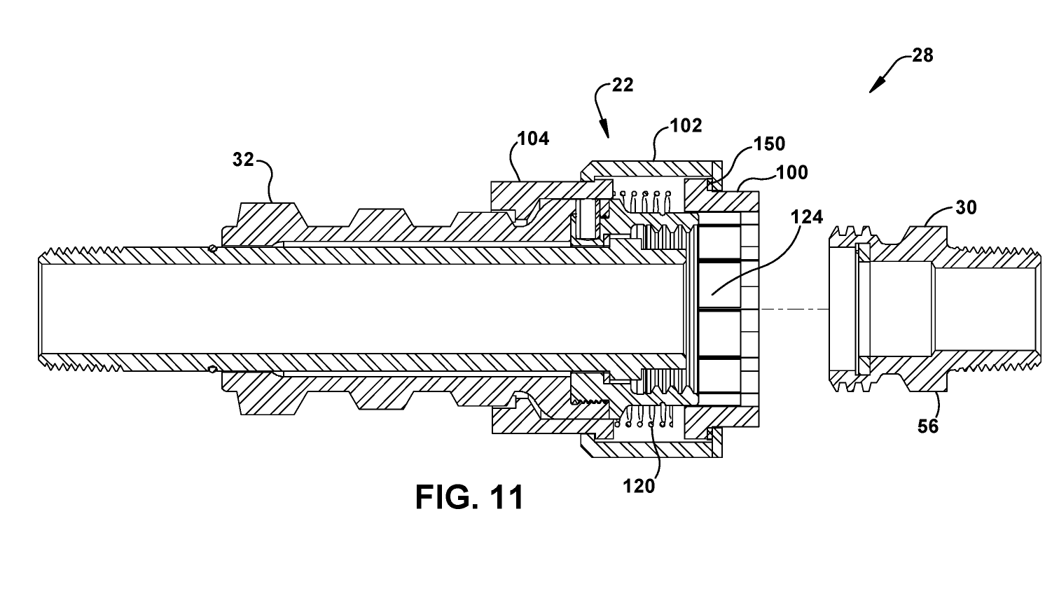

Referring now to FIGS. 9-11, in use of the exemplary coupling adapter 22, the coupling sleeve 102 may be axially shifted in a rearward direction towards the tank adapter 32, thus causing compression of the resilient member 120 and axial shifting of the locking slide 100 along with the coupling sleeve 102 from its extended locking position shown in FIG. 9 towards its retracted release position shown in FIG. 10. In the retracted release position of the locking slide 100 (FIG. 10), the locking slide 100 is not rotationally engaged with the hose adapter 30 that is attached to the tank adapter 32. The hose adapter 30, the tank adapter 32, or both, may be rotated in the unthreading direction without interference from the cooperating elements 150, allowing separation of the hose adapter 30 relative to the tank adapter 32. Release of the coupling sleeve 102 will cause to the locking slide 100 to move back to the extended locking position via the resilient member 120, as shown in FIG. 11.

To attach the separated tank adapter 32 and hose adapter 30 from the unattached orientation shown in FIG. 11 to the attached orientation shown in FIG. 9, no retraction of the coupling sleeve 102 and the locking slide 100 is required. Though movement of the locking slide 100 to the retracted release position does not prevent threading attachment of the tank adapter 32 and hose adapter 30. When in the extended locking position, the cooperating elements 150 do not prevent rotation of the locking slide 100 relative to the coupling sleeve 102 in a threading rotational direction. As such, the cooperating elements 150 allow threaded attachment of the hose adapter 30 with the tank adapter 32 regardless of the axial position of the locking slide 100 along the tank adapter 32. In summary, via the cooperating elements 150, the locking slide 100 and the coupling sleeve 102 are jointly configured to allow rotational engagement of the hose adapter 30 with the tank adapter 32 via rotation of the tank adapter 32 or the hose adapter 30 in a threading rotational direction, while the locking slide 100 is in either of the extended locking position or the retracted release position.

Accordingly, while the locking slide 100 is in the extended position, after at least a portion of the hose adapter 30 is threaded on the tank adapter 32, and with continued rotation in the threading rotational direction, the non-circular outer surface 56 of the hose adapter 30 is brought into engagement with the non-circular engaging surface 124 of the locking slide 100. The surfaces 56 and 124 are caused to engage, and thus the locking slide 100 and hose adapter 30 are caused to rotate together, with the cooperating elements 150 being configured via their shapes to pass one another, allowing the rotation of the locking slide 100 relative to the coupling sleeve 102 in the threading direction.

As explained, the cooperating elements 150 do not, however, allow rotation of the locking slide 100, and the hose adapter 30 engaged therewith, relative to the coupling sleeve 102 in an unthreading direction. In other words, via the cooperating elements 150, the locking slide 100 and the coupling sleeve 102 are jointly configured to prevent rotational disengagement of the hose adapter 30 relative to the tank adapter 32 in an unthreading rotational direction when the locking slide 100 is in the extended locking position. This may be referred to as the anti-disengage function of the coupling adapter 22. Axial separation of the hose adapter 30 from the tank adapter 32 is prevented until the locking slide 100 is positively axially shifted against the biasing force of the resilient member 120 to the retracted release position, disengaging the joint rotational engagement of the locking slide 100 and the hose adapter 30.

The exemplary coupling adapter 22 therefor provides numerous advantages. During vibration of a cart or other vehicle having the coupling adapters 22, respective male and female adapters, such as the hose adapter 30 and the tank adapter 32, will be retained in engagement maintaining fluid connection between the adapters. As used herein, fluid connection may include liquid connection, gaseous connection, or a combination thereof. In addition to providing an anti-disengage function, the exemplary coupling adapter 22 also provides for a positive disengagement of the male and female adapters. In other words, a user must perform an action, the action here being the retraction of the coupling sleeve 102 and locking slide 100 relative to the tank adapter 32, prior to respectively unthreading the male and female adapters and disrupting the fluid connection therebetween.

Further, attachment of the male and female adapters is easier as a slide, such as the locking slide 100, is not required to be axially shifted to enable the male and female adapters to rotationally thread together. Moreover, the coupling adapter 22 in a default position is biased in a locked orientation. Thus, even if the locking slide 100 is retracted, the resilient member 120 automatically biases the coupling adapter 22 back into the locked orientation.

Referring still to FIGS. 9-11, there is also a method of providing locking engagement of first and second adapters, such as the hose adapter 30 and the tank adapter 32, using the coupling adapter 22. The method includes the steps of: (a) rotationally fixedly attaching the coupling sleeve 102 to the tank adapter 32, and (b) threading together the hose adapter 30 and the tank adapter 32 while the locking slide 100 is in the extended locking position, or while the locking slide 100 is in any axial position along the tank adapter 32.

The method further includes the step of engaging the locking slide 100 with the hose adapter 30 for joint rotational movement of the locking slide 100 with the hose adapter 30 in a first rotational direction allowing threading engagement of the hose adapter 30 and the tank adapter 32. The method also includes the step of preventing separation of the hose adapter 30 and the tank adapter 32 when threadedly engaged via interengagement of the cooperating elements 150 of the locking slide 100 and the coupling sleeve 102 when the locking slide is in the extended locking position.

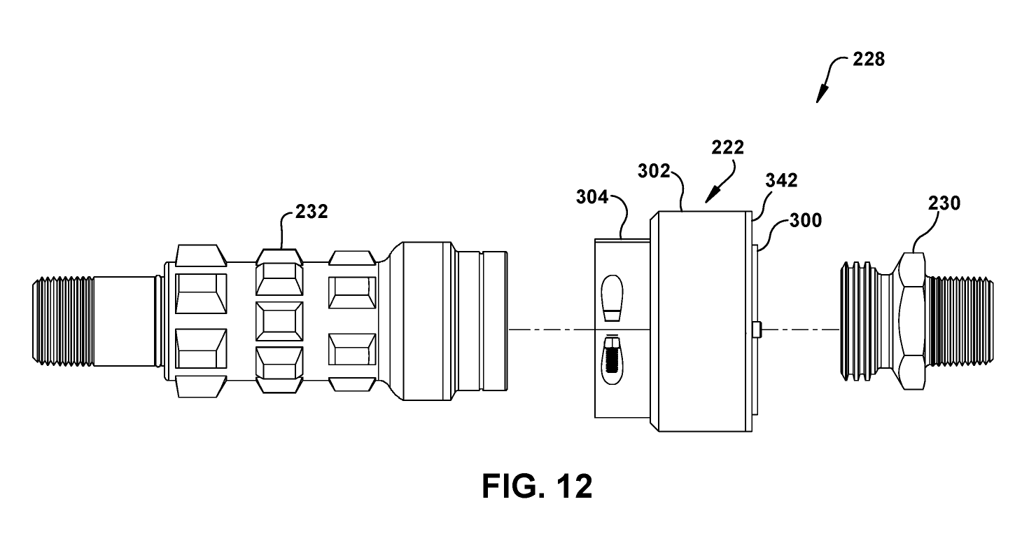

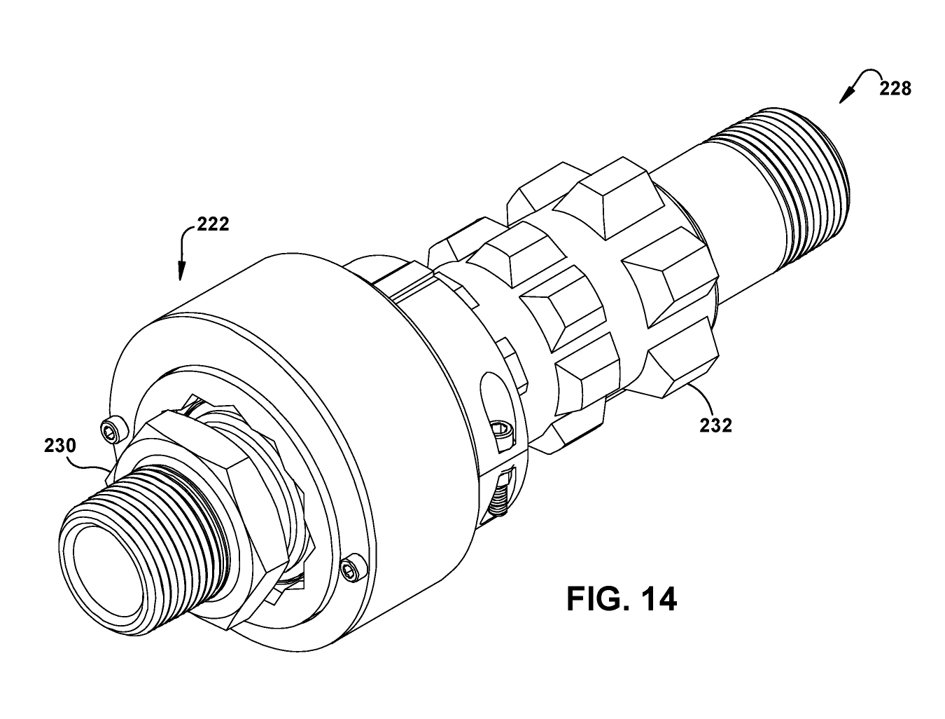

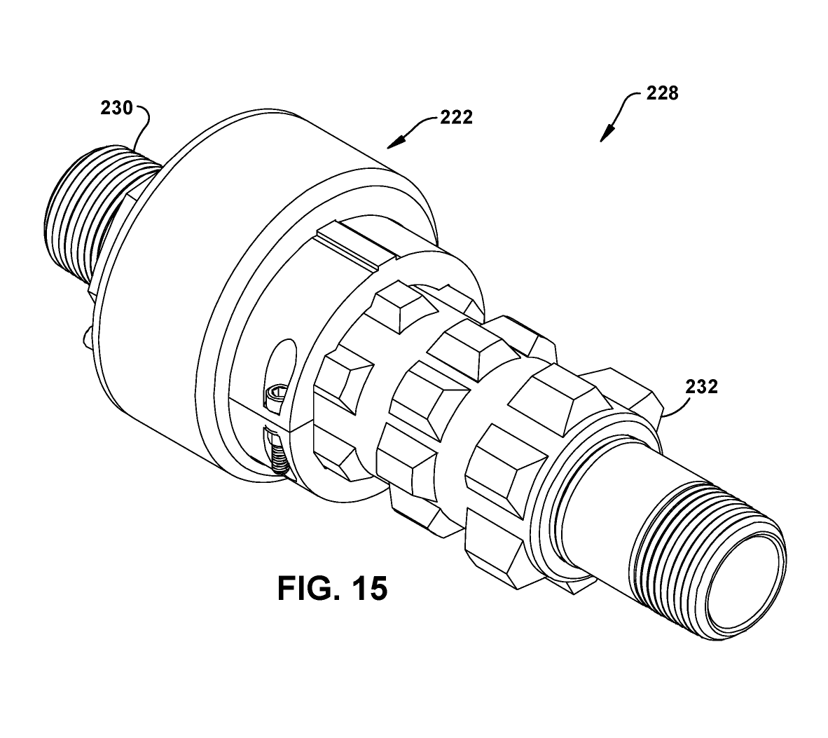

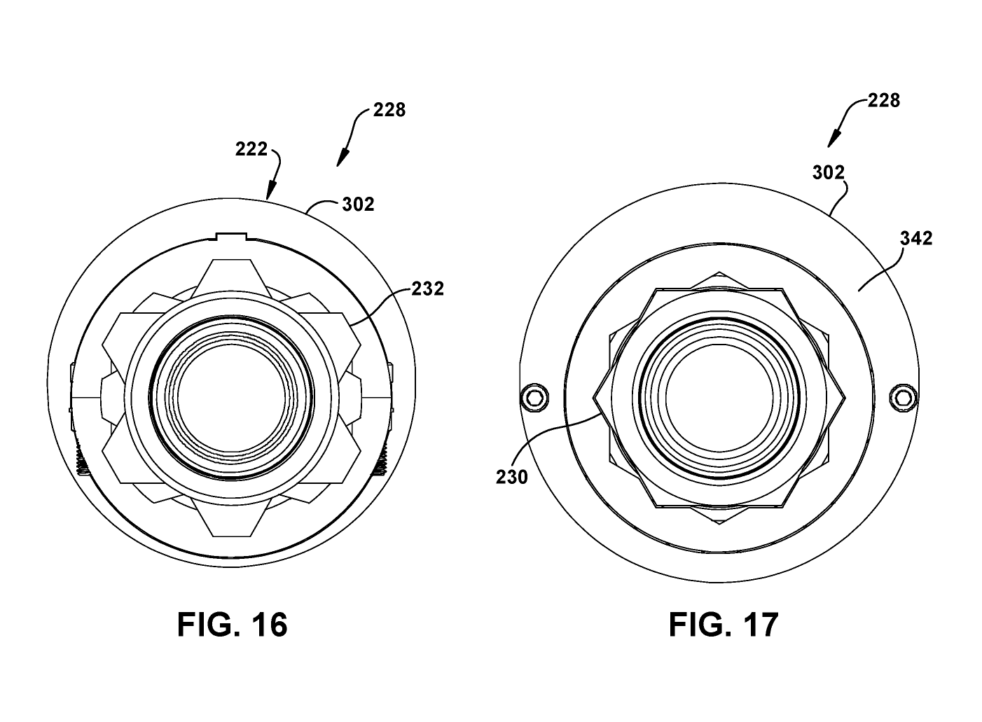

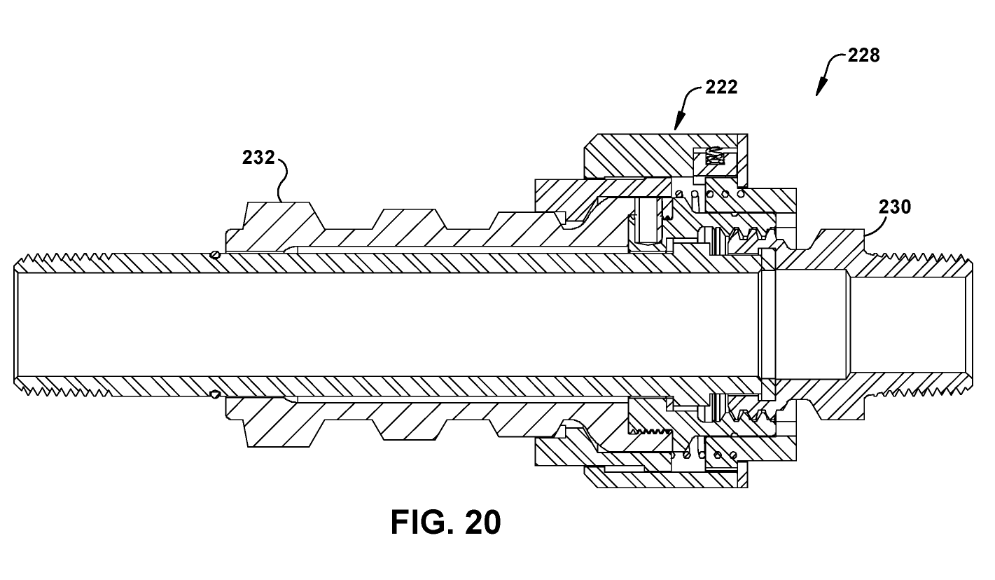

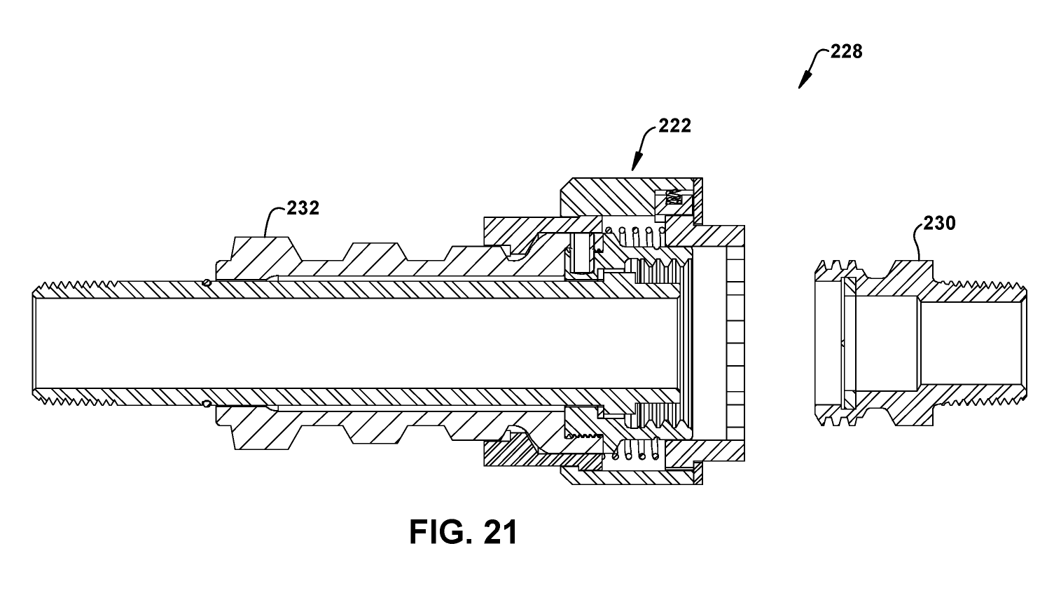

Turning now to FIGS. 12-21, another exemplary embodiment of a coupling assembly 228 includes a coupling adapter 222. The coupling adapter 222 is substantially the same as the above-referenced coupling adapter 22, and consequently the same reference numerals but indexed by 200 are used to denote structures corresponding to similar structures in the coupling adapter 222. In addition, the foregoing description of the coupling adapter 22 is equally applicable to the coupling adapter 222 except as noted below. Moreover, it will be appreciated upon reading and understanding the specification that aspects of the exemplary coupling adapters 22 and 222 may be substituted for one another or used in conjunction with one another where applicable.

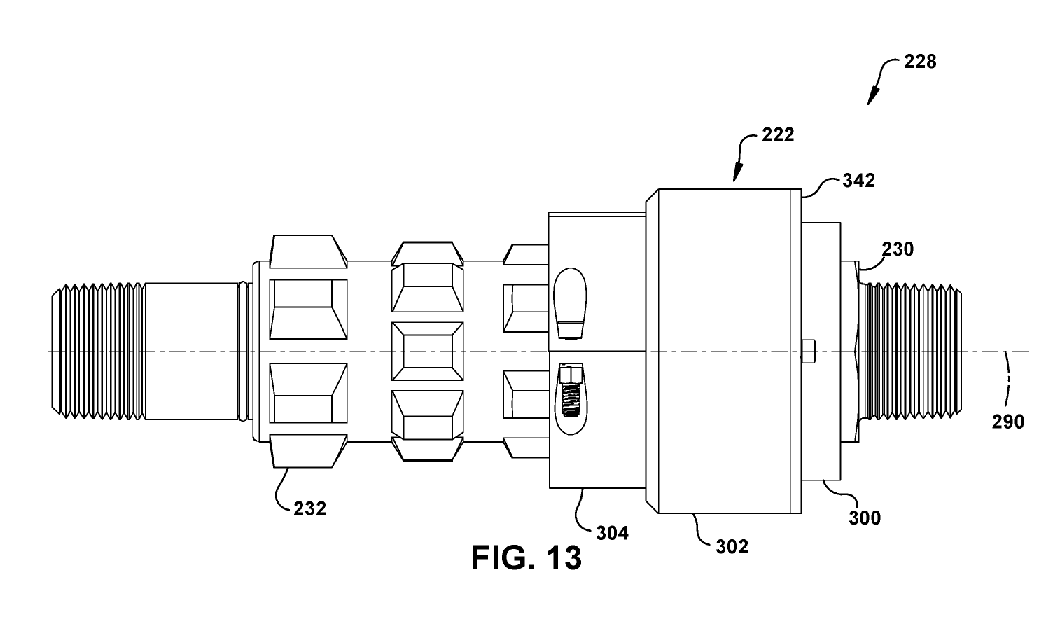

The exemplary coupling adapter 222 includes a union mount 304, coupling sleeve 302 and locking slide 300. A resilient member 320 biases the locking slide 302 towards an extended locking position for engaging the hose adapter 230. The locking slide 300 is axially shiftable along the tank adapter 232 and the union mount 304, along a central longitudinal axis 290 (FIG. 13), between an extended locking position and a retracted release position. In the illustrated embodiment, the coupling sleeve 302 has a retainer member 342 that is coupled to the coupling sleeve 302.

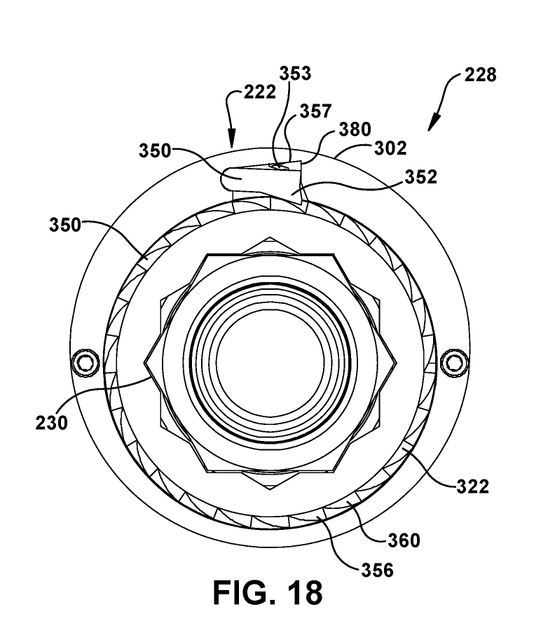

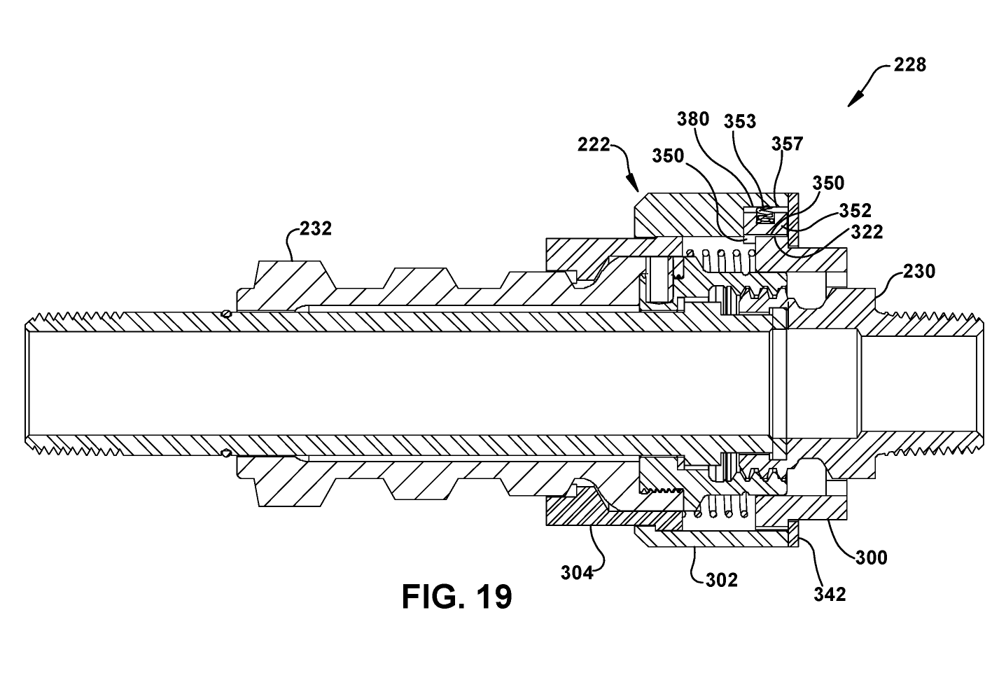

Turning particularly to FIGS. 18 and 19, the coupling sleeve 302 and locking slide 300 each include cooperating elements 350 that rotationally interfere with one another when the locking slide 300 is in the extended locking position to restrict rotation of the locking slide 300 relative to the coupling sleeve 302, and relative to the union mount 304, in a threading rotational direction of the hose adapter 230 and tank adapter 232. The cooperating elements 350 of the locking slide 300 are disposed on a radially outward surface 360, such as of the boss 322. The cooperating elements 350 of the locking slide 300 include interference projections 356 on the radially outward surface 360. The cooperating elements 150 of the coupling sleeve 302 are disposed on a radially inward surface 380.

Different from the coupling adapter 22, the cooperating elements 350 of the coupling sleeve 302 include an interference tooth 352 that is resiliently biased radially inwardly via a resilient member 353, such as a leaf spring. The interference tooth 352 is rotatable along a pin (not shown) of the coupling sleeve 302 disposed in a pocket 357 in the radially inward surface 380. The interference tooth 352 is resiliently biased towards the interference projections 356 of the locking slide 300, restricting joint rotation of the locking slide 300 and the hose adapter 230 relative to the coupling sleeve 302 in one rotational direction and allowing rotation of the locking slide 300 and the hose adapter 230 relative to the coupling sleeve 302 in an opposite rotational direction.

In summary, there is a coupling adapter 22, 222 for locking engagement of a first adapter 30, 230 to a second adapter 32, 232. The coupling adapter 22, 222 includes a locking slide 100, 300 for engaging the first adapter 30, 230 and a coupling sleeve 102, 302 for attaching the locking slide 100, 300 to the second adapter 30, 230 while allowing axially shifting movement of the locking slide 100, 300 along a central longitudinal axis 90, 290 of the coupling adapter 22, 222 between a retracted release position allowing release of the first adapter 30, 230 from the locking slide 100, 300 and an extended locking position preventing release of the first adapter 30, 230 from the locking slide 100, 300. The coupling adapter 22, 222 also includes a resilient member 120, 320 for resiliently biasing the locking slide 100, 300 towards its extended locking position. The locking slide 100, 300 and the coupling sleeve 102, 302 have cooperating elements 150, 350 that rotationally interfere with one another when the locking slide 100, 300 is in the extended locking position to restrict rotation of the locking slide 100, 300 relative to the coupling sleeve 102, 302 in at least one direction.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A coupling adapter for locking engagement of corresponding first and second adapters of a fluid transfer system, the coupling adapter including:
a locking slide for engaging the first adapter;
a coupling sleeve for attaching the locking slide to the second adapter while allowing axially shifting movement of the locking slide along a central longitudinal axis of the coupling adapter between a retracted release position allowing release of the first adapter from the locking slide and an extended locking position preventing release of the first adapter from the locking slide; and
a resilient member for resiliently biasing the locking slide towards its extended locking position;
wherein the locking slide and the coupling sleeve have cooperating elements that rotationally interfere with one another when the locking slide is in the extended locking position to restrict rotation of the locking slide relative to the coupling sleeve in at least one direction.

2. The coupling adapter of claim 1, wherein the locking slide is configured to couple with the first adapter for joint rotational movement of the locking slide and the first adapter when the locking slide is in the extended locking position.

3. The coupling adapter of claim 1, wherein the cooperating elements rotationally interfere with one another when the locking slide is in the extended locking position to restrict joint rotation of the locking slide and the first adapter relative to the coupling sleeve in at least one direction.

4. The coupling adapter of claim 1, wherein the locking slide has at an end for receiving the first adapter a non-circular engaging surface for restricting rotation of the first adapter relative to the locking slide.

5. The coupling adapter of claim 1, wherein the cooperating elements are configured to rotationally interfere with one another when the locking slide is in the extended locking position to prevent rotational separation of the first and second adapters from a threadedly engaged orientation.

6. The coupling adapter of claim 1, wherein the cooperating elements are configured to allow rotational connection of the first and second adapters from a separated orientation to a threadedly engaged orientation when the locking slide is in the extended locking position.

7. The coupling adapter of claim 1, wherein the cooperating elements include interengaging projections at each of the locking slide and the coupling sleeve that are shaped to pass one another in a first rotational direction of the locking slide but to impede rotational movement past one another in a second and opposite rotational direction of the locking slide.

8. The coupling adapter of claim 1, wherein the cooperating elements of the locking slide are disposed on a radially outward surface and the cooperating elements of the coupling sleeve are disposed on a radially inward surface.

9. The coupling adapter of claim 1, wherein the cooperating elements of the locking slide and the coupling sleeve are disposed on corresponding axial end surfaces of the locking slide and the coupling sleeve.

10. The coupling adapter of claim 1, wherein the coupling adapter includes a union mount for fixedly attaching to the second adapter and for attaching the coupling sleeve to the second adapter, wherein the coupling sleeve is rotationally fixed relative to the union mount while allowing joint axially shifting movement of the coupling sleeve and the locking slide along the central longitudinal axis of the coupling adapter.

11. The coupling adapter of claim 1, wherein the coupling sleeve is configured for rotational fixation relative to the second adapter while allowing joint axially shifting movement of the coupling sleeve and the locking slide along the central longitudinal axis of the coupling adapter.

12. The coupling adapter of claim 1, in combination with the first and second adapters, wherein the first and second adapters each include cooperating Acme threads.

13. A method of providing locking engagement of the first and second adapters using the coupling adapter of claim 1, the method including the steps of:
rotationally fixedly attaching the coupling sleeve to the second adapter; and
threading together the first and second adapters while the locking slide is in the extended locking position.

14. The method of claim 13, further including the steps of:
engaging the locking slide with the first adapter for joint rotational movement of the locking slide with the first adapter in a first rotational direction allowing threading engagement of the first and second adapters.

15. A coupling adapter for locking in threaded engagement a tank adapter and a hose adapter, the coupling adapter comprising:
a locking slide for engaging the hose adapter; and
a coupling sleeve for attaching the locking slide and the tank adapter, where the coupling sleeve is rotationally fixed relative to the tank adapter;
wherein the locking slide is axially shiftable between a retracted release position allowing release of the hose adapter from the locking slide and an extended locking position preventing release of the hose adapter from the locking slide, and
wherein the locking slide and the coupling sleeve are jointly configured to allow rotational engagement of the hose adapter with the tank adapter via rotation of the tank adapter or the hose adapter in a threading rotational direction, and
wherein the locking slide and the coupling sleeve are jointly configured to prevent rotational disengagement of the hose adapter relative to the tank adapter via rotation of the tank adapter or the hose adapter in an opposite unthreading rotational direction when the locking slide is in the extended locking position.

16. The coupling adapter of claim 15, wherein the locking slide and the coupling sleeve are jointly configured to allow rotational engagement of the hose adapter with the tank adapter while the locking slide is in either of the extended locking position or the retracted release position.

17. The coupling adapter of claim 15, wherein each of the locking slide and the coupling sleeve have cooperating elements that rotationally interfere with one another when the locking slide is in the extended locking position to restrict rotation of the locking slide relative to the coupling sleeve in at least one direction.

18. The coupling adapter of claim 15, further including a resilient biasing member for biasing the locking slide to the extended locking position.

19. The coupling adapter of claim 15, wherein the locking slide has at an end for receiving the hose adapter a non-circular engaging surface for engaging a corresponding surface of the hose adapter for joint rotational movement therewith and for restricting rotation of the hose adapter relative to the locking slide.

20. A coupling assembly comprising:
a tank adapter for attachment to a tank;
a hose adapter for threaded attachment to the tank adapter and for attachment to a hose; and
a coupling adapter coupled to the tank adapter for locking together the tank adapter and the hose adapter in threaded engagement, the coupling adapter including
a locking slide axially shiftable along the tank adapter, the locking slide engageable with the hose adapter when axially biased in an extended locking position such that the locking is rotatable with the hose adapter upon threaded engagement of the hose adapter and the tank adapter,
a resilient biasing member biasing the locking slide in the extended locking position, and
a coupling sleeve attaching the locking slide to the tank adapter,
wherein each of the locking slide and the coupling sleeve have cooperating elements that rotationally interfere with one another when the locking slide is in the extended locking position to restrict rotation of the locking slide relative to the coupling sleeve in at least one direction, and
wherein the cooperating elements allow threaded attachment of the hose adapter with the tank adapter regardless of the axial position of the locking slide along the tank adapter.
